(19) United States
(12) Patent Application Publication
(10) Pub. No.: US 2013/0004273 A1
(43) Pub. Date: Jan. 3, 2013

(54) MINING SHUTTLE CAR

(76) Inventor: Anthony Webb, Herrin, IL (US)

(21) Appl. No.: 13/173,478

(22) Filed: Jun. 30, 2011

(51) Int. Cl. B62D 33/06; B60P 3/00; B60P 1/00

(52) U.S. Cl. 414/507; 296/190.09

(57) ABSTRACT

A shuttle car includes an enclosed personnel compartment, a hydraulic fan operable to pressurize the enclosed personnel compartment, a hydraulic air conditioner operable to control air temperature in the enclosed personnel compartment.

### TECHNICAL FIELD

This invention relates to mining equipment, and more particularly to shuttle cars.

### BACKGROUND

Shuttle cars are heavy-duty, rubber wheeled, low profile vehicles used in mining industries to transport mined material within subterranean mine shafts from a material face to a central loading area where the material can be efficiently transported to the ground surface.

### SUMMARY

Mining shuttle cars can have a pressurized personnel cabin, a hydraulically powered fan system, and a hydraulically powered air conditioning system. A pressurized personnel cabin can provide a safer environment for the shuttle car driver. The hydraulically powered fan system can be used to pressurize the personnel cabin, and to circulate air within the cabin to provide a more comfortable experience for the driver of the shuttle car. The hydraulic powered air conditioning system can provide relief to a shuttle car driver by reducing the temperature and the humidity of the air provided to the driver within the mine. By using hydraulic systems, as opposed to systems having electric components that are exposed to the external operating environment (e.g., exterior electric fans that could create a spark/arc and ignite volatile gases present), the shuttle car and the systems included (e.g., fan system and air conditioning system) can be used near, for example, a coal face where coal dust in the air can lead to potentially explosive conditions. The shuttle cars can provide a safe, comfortable operating experience for a driver, and still maintain high functionality for use throughout a mine shaft, and in particular near a coal face.

In one aspect, mining shuttle cars configured for transporting coal from a coal face through a mine include: an enclosed personnel compartment supported by a frame of the mining shuttle car; a hydraulic fan operable to pressurize the enclosed personnel compartment; and a hydraulic air conditioner operable to control air temperature in the enclosed personnel compartment.

In one aspect, mining shuttle cars include: an enclosed personnel compartment; a hydraulic pressure source; and a fan powered by the hydraulic pressure source, the fan operable to pressurize the enclosed personnel compartment.

In one aspect, mining shuttle cars include: an enclosed personnel compartment; a hydraulic pressure source; and an air conditioner powered by the hydraulic pressure source, the air conditioner operable to control air temperature in the enclosed personnel compartment.

Embodiments of these aspects can include one or more of the following features.

In some embodiments, mining shuttle cars include a central conveyor supported by the frame of the mining shuttle car, the central conveyor operable to transport coal from a first end of the mining shuttle car to an opposite second end of the mining shuttle car.

In some embodiments, mining shuttle cars include a hydraulic power source. In some cases, the hydraulic power source is operable to provide pressurized hydraulic fluid to the hydraulic fan and to the hydraulic air conditioner. The hydraulic power source can be operable to provide pressurized hydraulic fluid to the hydraulic fan and/or to the hydraulic air conditioner at between 500 and 1500 psi. In some cases, the hydraulic power source comprises on electric motor, hydraulic pump, relief valves, control valves and hoses and fittings.

In some embodiments, the hydraulic fan is operable to produce a volumetric flow rate between 200 cfm and 300 cfm.

In some embodiments, mining shuttle cars include a filtering system disposed in an air flow path through which the hydraulic fan moves ambient air into the enclosed personnel compartment, the filtering system configured to remove particles from air moving along the air flow path.

In some embodiments, mining shuttle cars include seals limiting the flow of gas through walls defining the enclosed personnel compartment.

In some embodiments, the hydraulic air conditioner has a cooling capacity of at least 13,000 BTUs.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a shuttle car.

FIG. 2 is a schematic view of a hydraulic system of the shuttle car shown in FIG. 1.

FIG. 3 is a schematic view of a hydraulic system of an air conditioning system included in the hydraulic system of FIG. 2.

FIG. 4 is a perspective view of a hydraulic fan used on the shuttle car shown in FIG. 1.

FIG. 5 is a schematic view of a hydraulic air conditioner used on the shuttle car shown in FIG. 1.

Like reference symbols in the various drawings indicate like elements.

### DETAILED DESCRIPTION

Shuttle cars are heavy-duty, rubber wheeled, low profile vehicles used in mining industries to transport mined material within subterraneous mine shafts from a material face to a central loading area where the material can be efficiently transported to the ground surface. Electric powered shuttle cars are generally used due to the operating environment of the shuttle car in underground mines where exhaust emissions from an internal combustion engine are typically considered unacceptable for health and safety reasons. Electric shuttle cars powered by batteries (i.e., instead of shuttle cars powered by electric cables from the surface) have greater capabilities for maneuvering complex mine shafts and allowing for the operation of multiple shuttle cars simultaneously. Mining shuttle cars typically include a central conveyor supported by the frame of the mining shuttle car to transport coal through the shuttle car (i.e., from a first end of the mining shuttle car to an opposite second end of the mining shuttle car).

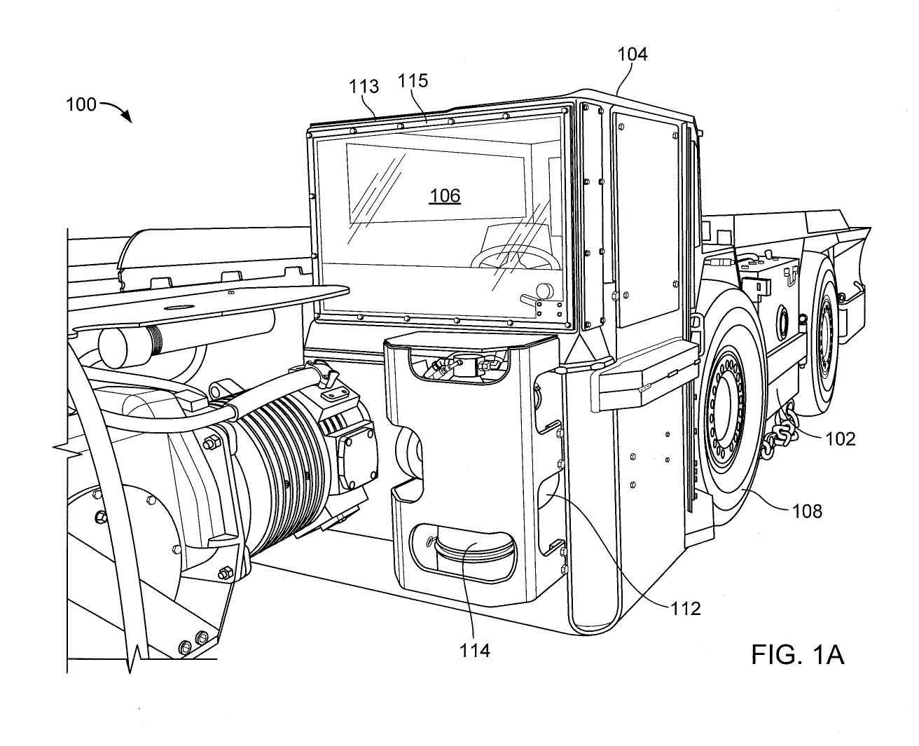

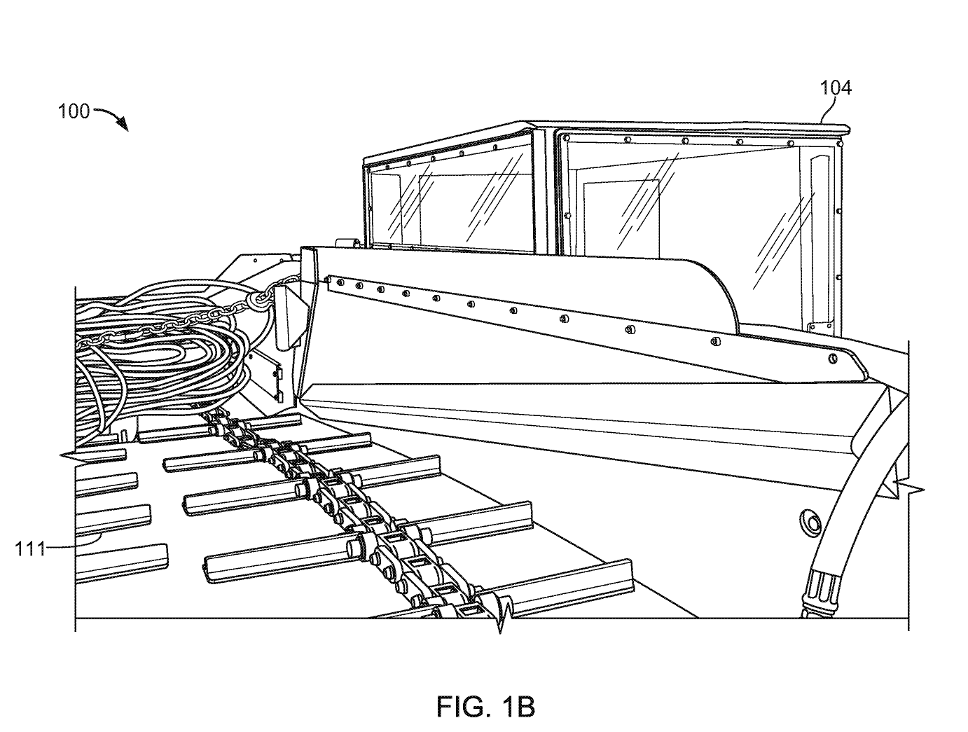

In the embodiment shown in FIGS. 1A and 1B, a shuttle car 100 has a frame structure 102, a pressurized personnel cabin 104 having transparent windows 106, a plurality of wheels 108, a hydraulic system 110 (see FIG. 2) providing pressurized hydraulic fluid to a hydraulic fan system 112 and a hydraulic air conditioning system 114, and an electromechanical drive system (not shown) connected to at least one of the wheels 108 that is configured to propel the car. The mining shuttle car 100 includes a central conveyor 111 supported by the frame of the mining shuttle car to transport coal through the shuttle car (i.e., from a first end of the mining shuttle car to an opposite second end of the mining shuttle car).

The shuttle car frame structure 102 can be designed according to the particular intended environment where the car will be used. In some embodiments, the frame can be a simple frame structure similar to those used for other commercial vehicles (e.g., two or more frame rails, onto which the majority of components are mounted) or the frame could be a unibody style frame as commonly used for passenger vehicles.

During use, an operator sits inside the pressurized cabin 104 to operate the various controls of a shuttle car 100 (e.g., to drive the shuttle car). As mentioned above, due to the environments in which shuttle cars are typically used (e.g., within mine shafts) that have poor air quality and can be dangerous, the operator can sit inside the pressurized cabin 104 to avoid the mine shaft conditions. In the shuttle car 100, the pressurized cabin 104 is constructed having a structural frame 113 and one or more windows 106 attached to the frame 113. The shuttle car 100 includes multiple large windows 106 to approximate the 360 degree visibility afforded by shuttle cars that do not include enclosed cabins. The frame 113 can be made of any material that can provide adequate protection for the driver, such as metal materials (e.g., steel materials, aluminum materials, or structural equivalents) or composite materials (e.g., carbon fiber or chopped fiber composites). The cabin windows 106 can be made of clear materials (e.g., glass, Lexan, polycarbonate, or other clear thermoplastics) that are attached to the frame 102. Depending on the design and materials chosen for the frame 113, various attachment methods can be used to attach windows 106 to the frame 113. Mechanical fasteners (e.g., bolts, screws, rivets, or clips) can be used to attach windows 106, as well as adhesives similar to those commonly used for securing automotive windshields. Since the cabin 104 is intended to be pressurized, a seal or sealing material 115 can be applied with fasteners used to secure windows 106. For example, a bead of a sealant (e.g., caulk, silicone, adhesive or similar material) or a strip of gasket material (e.g., foam, rubber, soft metals or similar material) can be applied between the window 106 and the frame 102 to provide a proper seal. The seal or sealing material 115 limits the flow of gas through the walls defining the enclosed personnel compartment. During use, the cabin 104 can be pressurized using fans.

The shuttle car 100 includes a hydraulically-powered fan 112 and a hydraulically-powered air conditioner 114 used during operation of the shuttle car 100. The shuttle car 100 has a hydraulic fluid system 110 that powers the fan 112 and the air conditioner 114. The hydraulic fluid system 110 can be driven by the electrical system. In some embodiments, an electric motor is provided to operate a hydraulic fluid pump to generate hydraulic fluid pressure to drive hydraulic systems 112, 114. Although many motors and hydraulic fluid pumps can possibly be used depending on the hydraulic systems included on a particular shuttle car, hydraulic pumps that produce output pressure ranging from 500 psi to 1,500 psi, having corresponding output flow rates of 7.2 gallons in³/min to 8.1 gallons in³/min are expected to perform adequately. In particular, the P-315 model pump from Parker, which produces output pressure of 1,500 psi and output flow rates of 8 gallons in³/min, has been shown suitable for proper hydraulic operation of the shuttle car 100. Other hydraulic pressure sources include, for example, a high-pressure fluid reservoir.

As shown in FIG. 2, the hydraulic fluid pressurized by the pump(s) 120 is distributed through hydraulic fluid distribution system 124 to the various hydraulic systems (e.g., the air conditioner/fan system, the steering system, brake system, and the hydraulic service jacks) of the shuttle car 100. In some embodiments, the shuttle car includes multiple pumps dedicated to provide pressurized hydraulic fluid to the hydraulic systems. The exemplary shuttle car hydraulic system provides hydraulic fluid to the air conditioner/fan system 112, 114, a steering system 123 used to drive the shuttle car, a brake system 125 used to provide braking capabilities to the shuttle car, and one of more hydraulic service jacks 127 that are used to perform various functions of the shuttle car (e.g., to lift and lower cabin components or coal handling devices). To operate the steering and brakes systems hydraulically, hydraulic actuators typically use the pressurized hydraulic fluid to translate the various mechanical components and systems.

The hydraulic lines 122 can be in the form of rigid and/or flexible hydraulic tubing portions. Rigid hydraulic tubing can be made of a metal or composite material (e.g., steel, stainless steel, aluminum, or similar metal) and can be used in locations of the car where it is not expected that the lines will be in motion during use (e.g., along a frame rail or similar rigid member). Flexible hydraulic tubing can be made of plastic or rubber materials (e.g., oil-resistant synthetic rubber, teflon, or thermoplastics) and include metal or wire braiding reinforcement within the tubing to provide adequate strength and fluid pressure capabilities. Flexible hydraulic tubing can be used where components are expected to be in motion during use (e.g., components that translate or vibrate). To provide hydraulic fluid to the shuttle car components, combinations of both rigid and flexible tubing portions can be used.

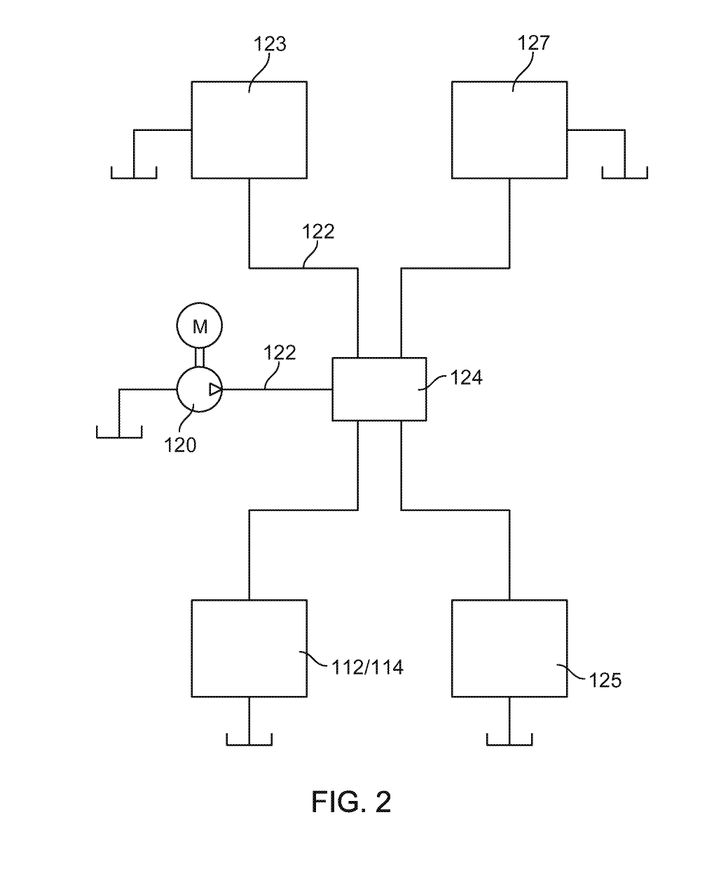

FIG. 3 shows a hydraulic schematic of an air conditioning/fan system used on a shuttle car. The air conditioning hydraulic system includes a pump 120, a hydraulic driven compressor motor 129, a hydraulic driven blower motor 131, a compressor controller 133, and a fan/blower controller 135. Hydraulic fluid is pressurized using the pump 120 that is operated by a motor (e.g., an electric motor or an internal combustion engine contained in a spark-containing enclosure). Pressurized hydraulic fluid is provided from the pump 120 to the compressor controller 133. The compressor controller 133 is a fluid flow controller that changes the flow of hydraulic fluid that is provided to the compressor motor 129 in order to change the speed of the compressor motor 129. The manually operated FC51 model variable flow controller from Brand Hydraulics has been found to be suitable.

Hydraulic fluid flows from the compressor motor 129 to the blower motor 131 to provide power to the blower motor 131. In addition to the flow provided from the compressor controller 133 to the compressor motor 129, excess flow of hydraulic fluid flows from the compressor controller 133 to a blower controller 135 in order to control the blower motor 131. The blower controller 135 is typically of the same type as the compressor controller 133 and controls the flow of hydraulic fluid to the blower motor 131, and thus controls the speed of the blower motor 131. A check valve 137 is included in-line between the blower controller 135 and the blower motor 131 to prevent back flow of fluid from the compressor motor 129 or the blower motor 131 into the blower controller 135.

Excess hydraulic fluid from the compressor motor 129 and the blower motor 131 is provided back to the hydraulic fluid tank of the shuttle car to be re-pressurized and re-circulated throughout the hydraulic systems. The air conditioning hydraulic system also includes a pressure relief valve 139 to prevent over-pressurization of the hydraulic system. The RL model line of pressure relief valves from Brand Hydraulics have been found to be suitable. Excess fluid flow from the pressure relief valve is also discharged into the hydraulic fluid tank of the shuttle car for re-use.

The shuttle car 100 includes a hydraulic fan 112 mounted on the outside of the personnel cabin 104. Some shuttle cars include multiple (2, 3, 4, or more) hydraulic fans. To avoid inadvertent combustion of volatile gases (e.g., natural gas) and/or fine coal dust that may be present in the operating environment near the coal face, the hydraulic fan 112 is designed such that there are no exposed electrical components that could arc or otherwise create a spark that could ignite the volatile gases/coal dust. For example, fans from Vision Air which can produce air flow of 200 to 300 cfm and operates on 500 psi of hydraulic fluid pressure has been shown to provide sufficient air flow to adequately pressurize the shuttle car cabin 104. As shown in FIG. 1, the fan 112 can be mounted to the exterior of the cabin 104 of the shuttle car 100 to provide air to the cabin 104. The fan 112 can be configured to fit on the cabin 104 in a space envelope of 2.1 to 2.3 square feet and can be mounted using mechanical fasteners (e.g., bolts, screws, rivets, or similar devices) or it could alternatively be welded to the cabin 104.

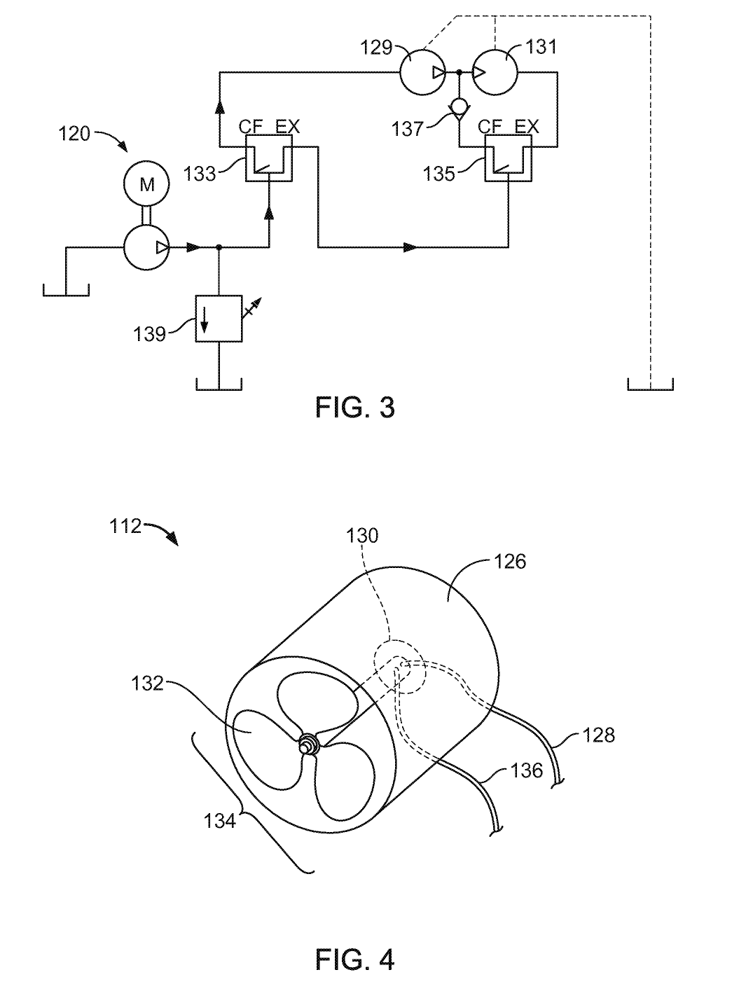

As shown in FIG. 4, in some embodiments, a hydraulic fan 112 has a body 126, a hydraulic fluid inlet 128, and impeller 130 connected to a fan blade 132, an air outlet duct 134, and a hydraulic fluid outlet 136. During use, high pressure hydraulic fluid is provided from the shuttle car hydraulic system 110 and forced through the hydraulic fluid inlet 128. As the fluid enters the inlet 128, the energy of the high pressure hydraulic fluid is converted to kinetic energy, causing rotation of the fan impeller 130 and the fan blade 132, resulting in air blowing from the outlet duct 134. As the impeller 130 spins, lower pressure hydraulic fluid exits the hydraulic fluid outlet 136, and recirculates through the shuttle car's hydraulic system 110 to be pressurized for additional use.

The hydraulic fan(s) 112 can serve several functions. The fan 112 can act as a pressurizer, blowing air into the cabin 104. The air is filtered (e.g., using a HEPA filter or similar filter device) to remove dangerous particles (e.g., dirt, dust, coal dust, fumes, mist) from air provided to the cabin 104. Pressurizing the cabin 104 provides the shuttle car 100 driver with a supply of breathable air, and keeps dangerous air outside the cabin 104. To further provide higher quality air, the shuttle car 100 can have additional or alternate systems to remove dangerous gases (e.g., natural gas) that may be present in the air near a coal face. A hydraulic fan 112 can additionally or alternatively be used in a shuttle car 100 to provide air circulation within the cabin 104. Providing proper air circulation can assist in creating a safer, healthier, and more comfortable experience and work environment for a shuttle car driver.

In addition to hydraulic fans 112 discussed above, the environment inside the cabin 104 of a shuttle car 100 can further be improved by using an air conditioning system 114. Since shuttle cars can often be used in very hot and/or humid environments (e.g., in mine shafts), air conditioners 114 can provide significant improvements to the working conditions for driver's inside the cabin 104. However, as discussed above, flammable materials such as gases and coal dust can be present where shuttle cars 100 are used (e.g., near a coal face). Therefore, the air conditioner system 114 is designed to be powered by hydraulic fluid and has no electrical components exposed to the ambient air that could arc or otherwise create a spark that would ignite flammable materials in the ambient air.

Conventional air conditioning systems typically include thermostats to control the air conditioning systems. However, thermostats typically include devices that would create spark hazards (e.g., switches, electrical contacts, or electronic devices). In contrast, the shuttle car hydraulic air conditioning system does not include a thermostat to control the shuttle car air conditioning system. Instead, the shuttle car hydraulic air conditioning system is controlled and operated by changing the rotational speed of the compressor motor 129 and the blower motor 131, using the compressor controller 133 and the blower controller 135, respectively. To cool the shuttle car cabin, flow of hydraulic fluid to the compressor motor 129 and/or to the blower motor 131 is increased using the compressor controller 133 and/or the blower controller 135. The controllers are operated manually using levers or dials located inside the enclosed cab to change the flow to the compressor motor 129 and the blower motor 131.

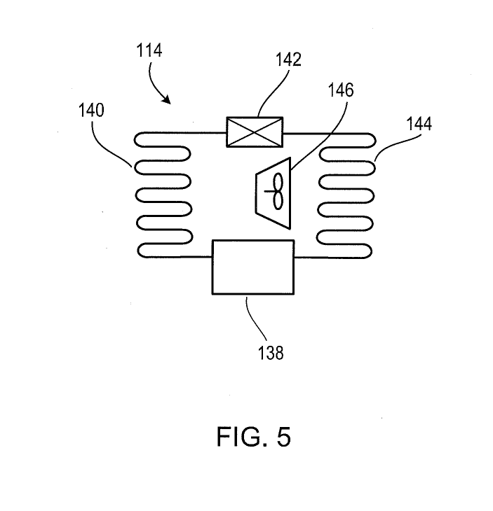

As illustrated in FIG. 5, the air conditioning system has a compressor 138 connected to a hot coil portion 140, an expansion valve 142 connected to the hot coil portion 140, and a cold coil portion 144 connected to the expansion valve 142 at one end and connected to the compressor 138 at the other end. During use of the air conditioner 114, the compressor 138 compresses refrigerant gas (e.g., Freon gas), which causes the temperature of the refrigerant to rise. The hot, high-pressure refrigerant gas then flows through the hot coil 140 where heat dissipates from the hot gas as it condenses into a liquid. The liquid refrigerant then flows through the expansion valve 142. The refrigerant flows through the cold coil portion 144 where the refrigerant absorbs heat of the air surrounding the cold coil portion 144 as the refrigerant evaporates. A fan 146 can blow air over the cold coil portion 144 and into the environment that is to be cooled.

In some embodiments, the hydraulic air conditioning system 114 can be configured to be mounted on the cabin 104, and fit in a space envelope of 2.8 to 3.0 square feet and can be mounted using mechanical fasteners (e.g., bolts, screws, rivets, or similar devices) or alternatively, the system could be welded to the cabin 104.

The performance requirements of a cabin air conditioning system 112 can vary depending on the size of the shuttle car 100 and the cabin 104, as well as the environment in which the car 100 will be used. Hydraulic air conditioning systems rated for 12,000 to 13,000 per hour btu are expected to sufficiently treat the air inside of a typical shuttle car cabin 104 having an interior volume of 50 to 75 cubic feet. For example, for a cabin of roughly 72 cubic feet, the 179CBR021 model hydraulic air conditioner from Kenway, which is rated at 13,000 btu provides sufficient cooling. During operation, the Kenway air conditioner operates on 1,300 psi of hydraulic fluid, which can be provided by the hydraulic pump discussed above. In some embodiments, the air conditioning system is configured to maintain the temperature within a shuttle car cabin within 65° F. to 75° F.

The shuttle car 100 typically has four wheels 108. The shuttle car wheels 108 have tires mounted on the wheels 108 that are configured to roll along a mine floor and move the shuttle car 100. Selection of the wheels 108 and tires depend on the intended use of the shuttle car 100 (e.g., the size of the mine shaft in which the car 100 will be used, and the ground conditions in the mine). Tires of conventional configuration (e.g., Goodyear 12:00×20, 24 ply or 14:00×24, 28 ply or equivalent tires by Michelin or other manufacturers) can typically be used for most operating environments. In some embodiments, a shuttle car 100 can have more than four wheels 108 to support the shuttle car 100. For example, the shuttle car 100 can have 5, 6, 7, 8, or more wheels 108.

The electromechanical drive system 116 used to propel the shuttle car 100 can be attached to one or more of the shuttle car wheels 108 in order to provide the shuttle car 100 with driving capabilities. The electromechanical drive system 116 can be in the form of one or more reversible electric motors (e.g., reversible, DC or AC electric motors) connected to the wheels 108. Although many types of electric motors can be used, motors producing 15 to 25 kW and operated on 480 to 995 V are expected to be sufficient. For example, the 25 kW model motor from Joy has been shown to be suitable. The AC motor produces 25 kW of power.

In some embodiments, the shuttle car 100 can have multiple electric motors, one motor used to rotate each of the wheels 108, directly connected to the wheels 108 by a mechanical connection (e.g., mounted using axles). In such embodiments, each motor is operated independently to drive the shuttle car 100. In other embodiments the electric motors can be indirectly connected to the wheels 108 using a transmission device. In such embodiments, it is possible to power multiple wheels 108 with one motor. For example one motor can be used to power two front wheels 108 and another motor used to power two rear wheels 108. Alternatively, separate motors can be used to power wheels 108 on either side of the shuttle car 100 (e.g., a motor to power the wheels on the left side of the car and a motor to power the wheels on the right side of the car).

To provide electrical power to the one or more electric motors, the shuttle car 100 has an electrical power system. The electrical power system can be in many forms (e.g., a battery system, a fuel cell system, or a capacitor system). In a battery system, one or more batteries can be disposed in or on the shuttle car 100 to provide electricity to the electric motors, as well as to provide electricity for other shuttle car systems (e.g., to power lights, to provide power to the personnel cabin, and/or to power one or more hydraulic pumps). The number of batteries, as well as their individual power ratings, can vary based on the particular design and the performance requirements of the shuttle car 100. The capacity and amperage of such a battery system can range from 750 amp hours to 1,500 amp hours, and the voltage can range from 128-240 volts for a given operating requirement.

A number of embodiments of the invention have been described. Nevertheless, it will be understood that various modifications may be made without departing from the spirit and scope of the invention.

Although the hydraulic fan system and the hydraulic air conditioning system have been described as two different components, in some embodiments the hydraulic fan and the hydraulic air conditioner can be combined into one hydraulic device that can cool the cabin air and pressurize the cabin.

Although the hydraulic fan system and the hydraulic air conditioning system have been described as being attached to the exterior surface of the personnel cabin, in some embodiments, other mounting locations are possible. For example, the hydraulic fan system and the hydraulic air conditioning system can be mounted on the exterior surface of other portions of the shuttle car or inside the shuttle car and utilize air ducts to provide air to the personnel cabin.

Other embodiments are within the scope of the following claims.

What is claimed is:

1. A mining shuttle car configured for transporting coal from a coal face through a mine, the mining shuttle car comprising:
an enclosed personnel compartment supported by a frame of the mining shuttle car;
a hydraulic fan operable to pressurize the enclosed personnel compartment; and
a hydraulic air conditioner operable to control air temperature in the enclosed personnel compartment.

2. The mining shuttle car of claim 1, further comprising a central conveyor supported by the frame of the mining shuttle car, the central conveyor operable to transport coal from a first end of the mining shuttle car to an opposite second end of the mining shuttle car.

3. The mining shuttle car of claim 1, further comprising a hydraulic power source.

4. The mining shuttle car of claim 3, wherein the hydraulic power source is operable to provide pressurized hydraulic fluid to the hydraulic fan and to the hydraulic air conditioner.

5. The mining shuttle car of claim 4, wherein the hydraulic power source is operable to provide pressurized hydraulic fluid to the hydraulic fan and to the hydraulic air conditioner at between 500 and 1,500 psi.

6. The mining shuttle car of claim 2, wherein the hydraulic power source comprises an electric motor, a hydraulic pump, relief valves, control valves, hoses and fittings.

7. The mining shuttle car of claim 1, wherein the hydraulic fan is operable to pressurize the personnel compartment above ambient conditions.

8. The mining shuttle car of claim 1, wherein the hydraulic fan is operable to produce a volumetric flow rate between 200 cfm and 300 cfm.

9. The mining shuttle car of claim 1, further comprising a filtering system disposed in an air flow path through which the hydraulic fan moves ambient air into the enclosed personnel compartment, the filtering system configured to remove particles from air moving along the air flow path.

10. The mining shuttle car of claim 1, further comprising seals limiting the flow of gas through walls defining the enclosed personnel compartment.

11. A mining shuttle car, comprising:
an enclosed personnel compartment;
a hydraulic pressure source; and
a fan powered by the hydraulic pressure source, the fan operable to pressurize the enclosed personnel compartment.

12. The mining shuttle car of claim 11, further comprising a central conveyor supported by a frame of the mining shuttle car, the central conveyor operable to transport mined material from a first end of the mining shuttle car to an opposite second end of the mining shuttle car.

13. The mining shuttle car of claim 11, wherein the hydraulic power source is operable to provide pressurized hydraulic fluid to the hydraulic fan at between 500 and 1500 psi.

14. The mining shuttle car of claim 13, wherein the hydraulic power source comprises electric motor, hydraulic pump, relief valves, control valves, hoses and fittings.

15. The mining shuttle car of claim 11, wherein the hydraulic fan is operable to pressurize the personnel compartment above ambient conditions

16. The mining shuttle car of claim 11, further comprising a filtering system disposed in an air flow path through which the hydraulic fan moves ambient air into the enclosed personnel compartment, the filtering system configured to remove particles from air moving along the air flow path.

17. A mining shuttle car, comprising:
an enclosed personnel compartment;
a hydraulic pressure source; and
an air conditioner powered by the hydraulic pressure source, the air conditioner operable to control air temperature in the enclosed personnel compartment.

18. The mining shuttle car of claim 17, wherein the hydraulic air conditioner has a cooling capacity of at least 13,000 BTUs.

19. The mining shuttle car of claim 17, further comprising a filtering system disposed in an air flow path through which the hydraulic fan moves ambient air into the enclosed personnel compartment, the filtering system configured to remove particles from air moving along the air flow path.

20. The mining shuttle car of claim 17, further comprising a central conveyor supported by a frame of the mining shuttle car, the central conveyor operable to transport mined material from a first end of the mining shuttle car to an opposite second end of the mining shuttle car.
